(19) United States
(12) Patent Application Publication
(10) Pub. No.: US 2026/0167045 A1
(43) Pub. Date: Jun. 18, 2026

(54) CHARGING STATION FAILURE INFORMATION PROVISION SYSTEM AND A METHOD FOR DETERMINING WHETHER A CHARGING STATION IS MALFUNCTIONING

(71) Applicant: HYUNDAI AUTOEVER CORP., Seoul (KR)

(72) Inventor: Jae Son Won, Seoul (KR)

(73) Assignee: HYUNDAI AUTOEVER CORP., Seoul (KR)

(21) Appl. No.: 19/415,366

(22) Filed: Dec. 10, 2025

(30) Foreign Application Priority Data
Dec. 18, 2024 (KR) 10-2024-0189367

(51) Int. Cl. B60L 53/66; B60L 53/62; B60L 53/68

(52) U.S. Cl. CPC B60L 53/66; B60L 53/62; B60L 53/68; B60L 2240/622; B60L 2240/68; B60L 2240/70; B60L 2240/80

(57) ABSTRACT

A charging station failure information provision system includes a vehicle navigation unit configured to receive charging station information from a charging station information unit, display the charging station information on a screen, transmit destination information and vehicle information to a connected service server unit and a charging station information unit, receive a vehicle route from the connected service server unit, and display vehicle route on the screen. The charging station information unit is configured to select static information and dynamic information of a charging station based on the destination information and the vehicle information. The connected service server unit is configured to derive charging stations excluding a charging station having a confirmed failure, based on the charging station information, and provide the derived charging stations to the vehicle navigation unit and the charging station information unit.

### CROSS REFERENCE TO RELATED APPLICATION

This application claims the benefit of and priority to Korea Patent Application No. 10-2024-0189367, filed on Dec. 18, 2024, the entire contents of which are hereby incorporated herein by reference.

### FIELD OF TECHNOLOGY

The present disclosure relates to an information provision system that can determine whether an electric vehicle charging station is malfunctioning and can provide electric vehicle charging station failure information to users.

### BACKGROUND

An electric vehicle charging station is a place where users of electric vehicles charge the electric vehicles with power required for the users of the electric vehicles. Various types of chargers are installed to provide fast charging or slow charging. The charging station includes a system that supplies and controls electricity, and software that operates the system. Technology for the electric vehicle charging station has continuously been developed to improve power supply stability and user convenience. The technology for the electric vehicle charging station aims to develop power converters, power management systems, payment and authentication systems, and remote control and monitoring techniques. The technology improves charging efficiency, and enables reliable power supply for users.

Failures occurring in the electric vehicle charging stations may cause significant inconvenience to the users. For example, in a case where charging is not available due to the failures when the users arrive at the charging stations, drivers of the electric vehicles are forced to find out another station, thereby resulting in wasted time and money. In order to prevent this disadvantage, some charging station systems provide failure information on the charging station to the users after checking whether the charging station is malfunctioning on a real-time basis.

A basic solution of this technology is a system that continuously monitors a status of the chargers and immediately notifies the users and operators when a problem occurs. A failure detection system is operated through sensors that detect an operating status, a communication status, and a power flow status of the chargers, and has a structure for immediately reporting any problem to a server when the problem is detected. This method enables the users and the operators to identity a status of the charging station on a real-time basis. Since the method provides the information to the users, the method can reduce the users'unnecessary visits to the charging station, and can provide reliable charging experiences to the users.

However, in many cases, existing electric vehicle charging station systems have difficulties in accurately predicting and notifying the users of failures. In particular, the electric vehicle charging stations may experience the failures due to a variety of factors. Main reasons of the failures include power supply issues, defects of the charger itself, communication errors, and the like. These failures may unexpectedly occur, and may cause inconvenience to the users without prior warning.

In many cases of the existing systems, the failures may be identified only after the failures occur. When a certain failure occurs, a maintenance team for the charging station needs to immediately respond to the failure. However, in most cases, the maintenance team has difficulties in taking immediate measures. For this reason, when the failure occurs, the users cannot use the charging station. Moreover, the users experience additional inconvenience since the users have to find an alternative charging station.

In addition, in many cases, in currently available charging station systems, information may not smoothly be updated on a real-time basis, and the users frequently have difficulties in identifying whether the charging station is malfunctioning. This disadvantage is particularly severe when the charging stations are scattered in many places and communication infrastructure for real-time monitoring of the status of each charging station is insufficient. Due to these limitations, the users travel to the charging station while expecting that the charging station properly functions. However, when the users arrive at the charging station, the users may often experience that the charging station is malfunctioning. This problem is particularly inconvenient in an area where fewer charging stations are installed or when the users travel a long distance. This inconvenience may impair reliability of the electric vehicles.

The discussions in this section are intended merely to provide background information and do not constitute an admission of prior art.

### SUMMARY

Embodiments of the present disclosure provide a technology in which whether the electric vehicle charging station is malfunctioning (e.g., is broken) is predicted in advance and this failure information is provided to the user s on a real-time basis.

Embodiments of the present disclosure provide a charging station failure information provision system and a method for determining whether a charging station is malfunctioning (e.g., is broken) and providing failure information to users on a real-time basis.

Embodiments of the present disclosure provide a charging station failure information provision system and a method for determining whether a charging station is malfunctioning or is broken, in which accurate information can be provided by segmenting failure information of charging stations.

Embodiments of the present disclosure provide a charging station failure information provision system and a method for determining whether the charging station is malfunctioning (e.g., it is broken), in which failure information of charging stations can be continuously updated to provide accurate information.

According to an embodiment of the present disclosure, a charging station failure information provision system is provided. The charging station failure information provision system includes a vehicle navigation unit configured to receive charging station information from a charging station information unit and display the charging station information on a screen. The vehicle navigation unit is also configured to transmit destination information and vehicle information to a connected service server unit and a charging station information unit, receive a vehicle route from the connected service server unit, and display vehicle route on the screen. The charging station information unit is configured to select static information and dynamic information of a charging station, based on the destination information and the vehicle information that are received from the vehicle navigation unit and the vehicle route received from a connected service server unit. The connected service server unit is configured to receive the charging station information from the charging station information unit, derive charging stations excluding a charging station having a confirmed failure, based on the received charging station information, and provide the derived charging stations to the vehicle navigation unit and the charging station information unit.

The destination information may include first destination information in which the charging station is a destination or a transit point, and second destination information in which the charging station is not the destination or the transit point. The first destination information and the second destination information may be distinguished and transmitted to the charging station information unit.

The vehicle information may include at least one of a location of a vehicle, whether a charging inlet door is open or closed, or whether a battery residual capacity is increased or decreased.

Location information of the vehicle may be generated based on an image received through a camera of the vehicle.

The static information of the charging station may include at least one of an address of the charging station, a number of charging ports, a charging speed, a charging method, operating hours, or a charging rate.

The dynamic information of the charging station may include at least one of a number of vehicles waiting for charging, a number of vehicles under charging, a charger status, a communication status, or road congestion around the charging station.

The failure information of the charging station may include first failure information including information on a defective charging port connector and second failure information including an error in a charger body.

In a case where the destination information received from the vehicle navigation unit is first destination information, based on determining that a vehicle arrives at the charging station, whether the charging station is malfunctioning may be determined by checking whether the charging station at which the vehicle arrives matches a charging station searched for through a camera of the vehicle, checking whether a charging inlet door is open, checking whether a battery residual capacity is increased or decreased, and checking whether the charging inlet door is closed.

In a case where the destination information received from the vehicle navigation unit is second destination information, whether the charging station is malfunctioning may be determined by checking whether a charging inlet door is open, identifying a charging station that matches a charging station searched for through a camera of the vehicle in charging stations around the vehicle which are searched for through GPS, checking a battery residual capacity is increased or decreased, and checking whether the charging inlet door is closed.

The first failure information may be generated based on determining that the charging inlet door is open and closed, even when the battery residual capacity is not increased.

The second failure information may be generated based on determining that the charging inlet door is open and closed and charging port connector connection is recognized, even when the battery residual capacity is not increased.

When the same failure information of the same charging station is received from another vehicle within a certain period of time after the failure information of the charging station is stored in the charging station database server for the first time, the charging station may be classified as a charging station having a confirmed failure.

According to another embodiment of the present disclosure, a method for determining whether a charging station is malfunctioning is provided. The method includes an information collection step of collecting destination information and vehicle information from a vehicle navigation unit, and collecting a vehicle route from a connected service server unit, a charging station information deriving step of selecting static information and dynamic information of a charging station from a charging station information unit, based on the collected information, and deriving failure information of the charging station, and a charging station information provision step of deriving a charging station excluding a charging station having a confirmed failure, based on derived charging station information, and providing the derived charging stations to the vehicle navigation unit and the charging station information unit.

The destination information may include first destination information in which the charging station is a destination or a transit point and second destination information in which the charging station is not the destination or the transit point. The first destination information and the second destination information may be distinguished and transmitted to the charging station information unit.

The static information of the charging station may include at least one of an address of the charging station, a number of charging ports, a charging speed, a charging method, operating hours, or a charging rate.

The dynamic information of the charging station may include at least one of a number of vehicles waiting for charging, a number of vehicles under charging, a charger status, a communication status, or road congestion around the charging station.

The failure information of the charging station may include first failure information including information on a defective charging port connector and second failure information including an error in a charger body.

In a case where the destination information received from the vehicle navigation unit is the first destination information, the method may include, based on determining that a vehicle arrives at the charging station, determining whether the charging station is malfunctioning by checking whether the charging station at which the vehicle arrives matches a charging station searched for through a camera of the vehicle, checking whether a charging inlet door is open, checking whether a battery residual capacity is increased or decreased, and checking whether the charging inlet door is closed.

In a case where the destination information received from the vehicle navigation unit is the second destination information, the method may include determining whether the charging station is malfunctioning by checking whether a charging inlet door is open, identifying a charging station that matches a charging station searched for through a camera of the vehicle in charging stations around the vehicle which are searched for through GPS, checking a battery residual capacity is increased or decreased, and checking whether the charging inlet door is closed.

According to still another embodiment of the present disclosure, a non-transitory computer-readable medium having instructions stored thereon is provided. The instructions, when executed by a computer, cause the computer to execute the method for providing charging station failure information.

As described above, according to embodiments of the present embodiment, it is possible to provide the charging station failure information provision system and the method for determining whether the charging station is malfunctioning (e.g., is broken), in which accurate information can be provided by segmenting the charging station failure information.

In addition, embodiments of the present disclosure provide the charging station failure information provision system and the method for determining whether the charging station is malfunctioning (e.g., is broken), in which accurate information can be provided by continuously updating the charging station failure information.

Technical aspects to be achieved in the present disclosure are not limited to the above-described technical aspects. Other technical aspects not described herein should be more clearly understood by those having ordinary skill in the art to which the present disclosure pertains, from the description below.

### BRIEF DESCRIPTION OF THE DRAWINGS

In order to enable one having ordinary skill in the art to understand the present disclosure, various forms of the present disclosure are described given by way of example with reference to the accompanying drawings, in which:

FIG. 1 is a schematic diagram illustrating a charging station failure information provision system according to an embodiment;

FIG. 2 is a schematic diagram illustrating an interaction of a vehicle navigation unit according to an embodiment;

FIG. 3 is a schematic diagram illustrating an interaction of a charging station information unit according to an embodiment;

FIG. 4 is a schematic diagram illustrating an interaction of a connected service server unit according to an embodiment;

FIG. 5 is a diagram illustrating a configuration of a vehicle under charging according to an embodiment;

FIG. 6 is a flowchart illustrating a method for determining whether a charging station is malfunctioning according to an embodiment;

FIG. 7 is a flowchart illustrating a first method for determining whether a charging station is malfunctioning according to an embodiment; and

FIG. 8 is a flowchart illustrating a second method for determining whether a charging station is malfunctioning according to an embodiment.

### DETAILED DESCRIPTION

Hereinafter, embodiments of the present disclosure are described in detail with reference to illustrative drawings. When the reference numerals are assigned to components in each drawing, it should be noted that the same reference numerals are assigned to the same components as possible, even when the same components appear in different drawings. In addition, in describing the present disclosure, where it was determined that detailed description of publicly known configurations or functions in the related art may obscure the concept of the present disclosure, the detailed description thereof has be omitted.

In addition, terms such as first, second, a, and b may be used to describe the components of the present disclosure. These terms are only intended to distinguish one component from another component, and do not limit a feature, an order, or a sequence of the components. When it is described that one component is “connected,” “coupled,” or “joined” to another component, one component may be directly connected or joined to another component. However, it should be understood that still another component may be “connected,” “coupled,” or “joined” between the components.

When a component, controller, device, element, apparatus, circuit, unit, or the like of the present disclosure is described as having a purpose or performing an operation, function, or the like, the component, controller, device, element, apparatus, circuit, unit or the like should be considered herein as being “configured to” meet that purpose or to perform that operation or function. Each component, controller, device, element, apparatus, circuit, unit, and the like may separately embody or be included with a processor and a memory, such as a non-transitory computer readable media, as part of the apparatus.

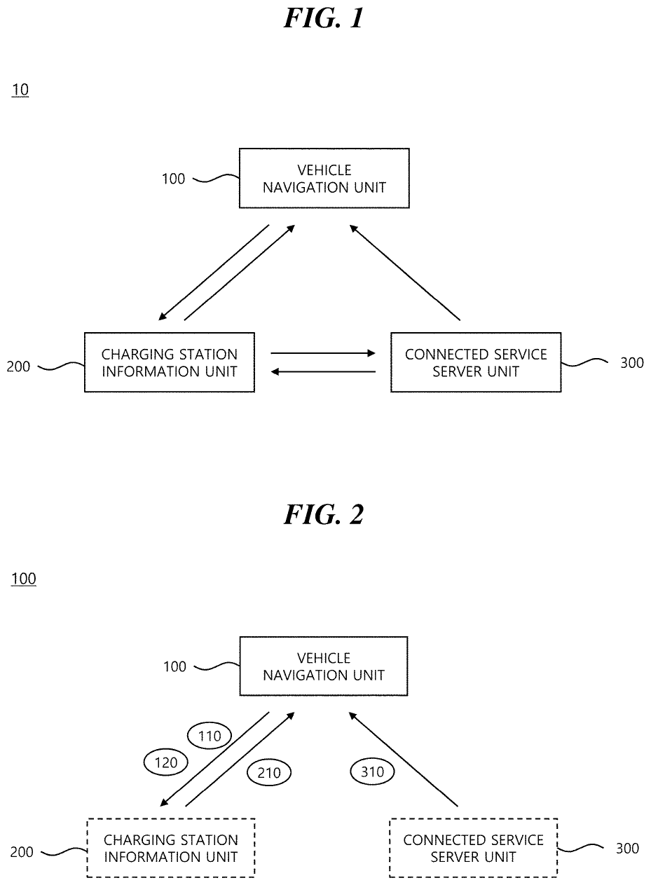

FIG. 1 is a schematic diagram illustrating a charging station failure information provision system according to an embodiment.

Referring to FIG. 1, a charging station failure information provision system 10 according to an embodiment may include a vehicle navigation unit 100, a charging station information unit 200, and a connected service server unit 300.

The vehicle navigation unit 100 may receive charging station information from the charging station information unit 200, may display the charging station information on a screen, may transmit destination information and vehicle information to the connected service server unit 300 and the charging station information unit 200, may receive a vehicle route from the connected service server unit 300, and may display the destination information and the vehicle information on the screen.

The charging station information unit 200 may select static information and dynamic information of the charging station, based on the destination information and the vehicle information received from the vehicle navigation unit 100 and the vehicle route received from the connected service server unit 300, may derive failure information of the charging station, may store the failure information of the charging station in a charging station database server, and may provide charging station information to the vehicle navigation unit 100 and the connected service server unit 300.

The connected service server unit 300 may receive the charging station information from the charging station information unit 200, may derive charging stations excluding a charging station having a confirmed failure, based on the received charging station information, and may provide the derived charging stations to the vehicle navigation unit 100 and the charging station information unit 200.

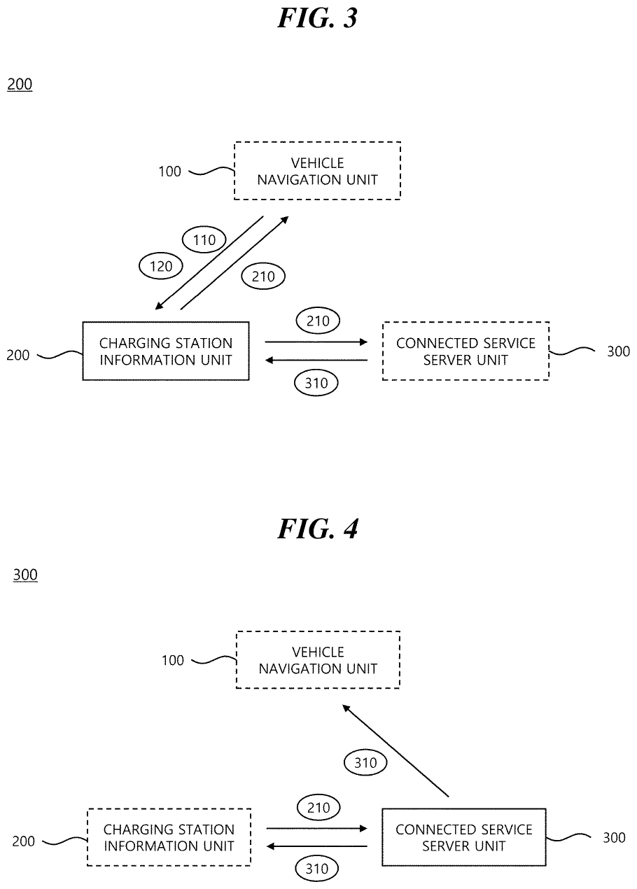

FIG. 2 is a schematic diagram illustrating an interaction of the vehicle navigation unit, according to an embodiment. FIG. 3 is a schematic diagram illustrating an interaction of the charging station information unit, according to an embodiment. FIG. 4 is a schematic diagram illustrating an interaction of the connected service server unit, according to an embodiment.

Referring to FIGS. 2-4, the charging station failure information provision system 10 according to an embodiment may include the vehicle navigation unit 100, the charging station information unit 200, and the connected service server unit 300.

The vehicle navigation unit 100 may receive charging station information 210 from the charging station information unit 200, may display the charging station information 210 on the screen, may transmit destination information 110 and vehicle information 120 to the connected service server unit 300 and the charging station information unit 200, may receive a vehicle route from the connected service server unit 300, and may display the vehicle route on the screen.

In an embodiment, the vehicle navigation unit 100 plays an important role in providing drivers with routes for efficiently using the charging station and assisting the drivers to establish a charging plan while the drivers drive vehicles, based on real-time charging station status information.

In an embodiment, the vehicle navigation unit 100 may provide information such as whether the charging station is malfunctioning (e.g., is broken) or whether the charging station is available, may allow users to select a reliable charging station, and may reduce unnecessary driving of the users. The vehicle navigation unit 100 may closely interact with the charging station information unit 200 and the connected service server unit 300, and may collect and analyze charging-related data to suggest a most suitable charging station to the users.

The vehicle navigation unit 100 may receive various static and dynamic information of the charging station from the charging station information unit 200, and may display the information on the screen. The static information of the charging station may include at least one of an address of the charging station, a number of charging ports, a charging speed, a charging method, operating hours, and/or a charging rate. Through this information, the user may select a basic charging station.

In addition, the vehicle navigation unit 100 may receive dynamic information including at least one of a number of vehicles waiting for charging, a number of vehicles under charging, a charger status, a communication status, and road congestion around the charging station, and may provide the dynamic information to the users. In this manner, the vehicle navigation unit 100 may assist the users to select the charging station, based on real-time conditions. For example, when the charging station selected as a destination of the users is malfunctioning (e.g., is broken) or when the charging station is unavailable due to a communication error, the vehicle navigation unit 100 may immediately display this information on the screen, and may thus enable the users to select an alternative charging station.

In addition, the vehicle navigation unit 100 may transmit destination information of the vehicle and current status information of the vehicle to the connected service server unit 300 and the charging station information unit 200. The reason is to provide more personalized charging station information to the users. Since a driving distance of the vehicle, a battery's remaining capacity, and a time required for charging to the server, the connected service server unit 300 may calculate a charging route suitable for the status of the vehicle.

In addition, vehicle information may be an important factor in assisting the users to select a charging station located close to a charging time point of the vehicle. For example, when the battery is nearly empty, the server may recommend a nearest charging station having no failure to the users, and may assist the users to quickly charge the battery.

Based on this vehicle information, the connected service server unit 300 may select a charging station from a list of currently available charging stations, may calculate a route, and may provide the calculated route to the vehicle navigation unit 100. During this process, the server may also consider power supply stability, a driving route of the vehicle, and an expected travel time.

For example, the server may reflect a real-time status of the charging station, and may guide the users to a charging station having a shortest waiting time or operating without any failure in available charging stations. When the charging station selected by the users is malfunctioning (e.g., is broken or suffers a communication failure) while the users access the charging station, the server may provide a new improved route to the charging station by immediately resetting the route, and may display the new route on a real-time basis on a screen of the vehicle navigation unit 100. This allows the users to flexibly respond to changes in the status of the charging station, and prevent problems that may occur when the drivers access the charging station.

In addition, the vehicle navigation unit 100 may have a function of recommending a charging station suitable for charging-required time point in view of not only this route but also a distance and an estimated driving time to a destination selected by the users. This is an important function for securing the route in advance in accordance with the status of the charging station, especially when the users travel a long distance or pass through an area in which the number of charging stations is insufficient.

For example, when the charging station near the destination has a problem while the users travel a long-distance or the users have to await charging for a long time, based on data received from the server, the vehicle navigation unit may guide the users to charge the battery by adding another charging station to the route before arrival. This configuration may adopt technology for analyzing an expected driving distance and predicting a status and a waiting time of the charging station, thereby enabling safe and efficient driving of the users.

Functions of the vehicle navigation unit 100 may be operated not only as a simple route guidance function, but also as a comprehensive charging management system based on connectivity with the charging station. For example, real-time charging station status information may allow the users to plan an access strategy to the charging station in advance by reflecting an expected situation upon arrival and a possible change in the charging station. Through these functions, the vehicle navigation unit 100 may enable the users to always select a reliable charging station while the users access the charging station, and may minimize unexpected inconveniences caused by the failure of the charging station when the users arrive at the charging station.

The charging station information unit 200 may select static information and dynamic information of the charging station, based on the destination information 110 and the vehicle information 120 received from the vehicle navigation unit 100 and the vehicle route 310 received from the connected service server unit 300, may derive the failure information of the charging station, may store the derived failure information in the charging station database server, and may provide the charging station information 210 to the vehicle navigation unit 100 and the connected service server unit 300.

In an embodiment, the charging station information unit 200 collects status information of the charging station on a real-time basis, analyzes the status information, and transmits the analyzed status information to the vehicle navigation unit 100 and the connected service server unit 300. The charging station information unit 200 may play a role in providing an efficient charging path to the users by accurately monitoring the status of the charging station and deriving the failure information and real-time charging availability. The charging station information unit 200 may select a status of each charging station, based on the static information and the dynamic information of the charging station, may extract the failure information, and may store the failure information in the charging station database server, thereby providing reliable real-time information for the users and operators.

The charging station information unit 200 may select required charging station information, based on the destination information 110 and the vehicle information 120 received from the vehicle navigation unit 100 and the vehicle route 310 received from the connected service server unit 300. This charging station information may include the static information such as a location of the charging station, a charging method, and the number of chargers, and the dynamic information such as a real-time standby status, whether the charging station is malfunctioning (e.g., is broken), and a communication status. Through this information, the charging station information unit may determine current requirements of the charging station needed by the vehicle, and may select and manage data essential on a real-time basis to provide the charging station information when the users access to the destination.

In addition, the charging station information unit 200 may continuously analyze the status data of each charging station to derive the failure information. For example, the charging station information unit 200 may continuously monitor a power supply status, an internal status of devices including the chargers, and a network communication status through various sensors, and may adopt an algorithm for determining whether the charging station is malfunctioning (e.g., is broken), based on this data.

For example, when a voltage of the charger falls outside a normal range or normal charging is unavailable, the charging station information unit 200 determines this case as a potential failure, and derives the failure information. The failure information derived in this way may be stored in the charging station database server, and may enable the users and the operators to identify the status of the charging station at any time.

In addition, the charging station information unit 200 may transmit the failure information on a real-time basis to the vehicle navigation unit 100 and the connected service server unit 300 to reflect availability of the charging station. When a status of the selected charging station is changed to a failure status while the users access the charging station along the route, the charging station information unit 200 may quickly update the information. In this manner, the charging station information unit 200 may guide the users to immediately reset the route, or may suggest the users to select an alternative charging station.

For example, the vehicle navigation unit 100 may guide the users again to select an accessible charging station while the users access the charging station in accordance with the failure information received from the charging station information unit 200, and the connected service server may recommend the users to select a nearby charging station having a short waiting time and charging availability.

The charging station information unit 200 may automate data collection and analysis to derive the failure information of the charging station, and may improve operational efficiency. This system may utilize machine learning and big data analysis to predict failure patterns, and may detect potential failure scenarios through the prediction.

A function of the charging station information unit 200 to derive and provide the failure information may greatly assist the users to select the charging station, based on reliable information. The failure information not only indicates whether the charging station is malfunctioning (e.g., is broken), but may also allow the drivers to save time and money by avoiding a charging station having a high potential failure.

For example, the charging station information unit 200 may minimize a possibility that the charging station is unusable due to the failure when the users arrive at the charging station while the users travel a long distance.

The connected service server unit 300 may receive the charging station information 210 from the charging station information unit 200, and based on the received charging station information 210, the connected service server unit 300 may derive a charging station excluding a charging station having a confirmed failure, may generate the vehicle route 310, and may provide the generated vehicle route 310 to the vehicle navigation unit 100 and the charging station information unit 200.

In an embodiment, the connected service server unit 300 is a system operated in close conjunction with the charging station information unit 200 and the vehicle navigation unit 100 to provide the users with information on the charging station and the driving route. In particular, the system may provide the users with a route including only the reliable charging station by reflecting the failure information of the charging station on a real-time basis. The connected service server unit 300 may receive a real-time status and related information of the charging station from the charging station information unit, may analyze the real-time status and the related information of the charging station, and may select the charging station excluding the charging station having the confirmed failure, thereby providing the users with an efficient route.

The connected service server unit 300 may accurately identify a status of the charging station, based on the charging station information 210 provided by the charging station information unit 200. The charging station information unit 200 may identify the static information and the dynamic information of each charging station. The static information and the dynamic information may include not only basic information such as a location of the charging station, a charging speed, and the number of chargers, but also a real-time status of the charging station, whether the charging station is malfunctioning (e.g., is broken), and a communication status. The connected service server unit 300 determines the availability of the charging station on a real-time basis through the identified information, and secures a criterion for excluding the charging station having the confirmed failure when recommending the charging station suitable for the users. For example, when it is confirmed that the charging station is currently malfunctioning (e.g., is currently broken), the connected service server unit 300 may immediately exclude the charging station having the confirmed failure, and may select only the available charging station.

The connected service server unit 300 may perform a process of deriving the charging station to the users, based on the provided charging station information 210. In this case, the charging station may be determined by comprehensively considering a battery residual capacity, a current location, a distance to a driving destination, an expected charging time, and the like of the vehicle of the users. In particular, when the users travel a long distance or pass through an area having an insufficient charging infrastructure, the server may design a route to provide a stable route to the users by identifying the available charging stations in advance. In this process, detailed information such as a charging waiting time and a charging speed of each charging station may be considered together, and the server may calculate and provide a route including the charging station information to the users, based on this detailed information.

A route setting process of the connected service server unit 300 may play an important role in maximizing user experience. The connected service server unit 300 may generate a route by adding the charging station information. This route may be frequently updated by reflecting a real-time status and failure information of the charging station.

For example, when the charging station located on the route set by the users becomes unavailable due to a sudden breakdown or a communication failure, the server quickly reflects this situation, and resets the route of the vehicle to another charging station. In this case, the connected service server unit 300 may quickly derive an alternative available charging station, provides the users with the alternative available charging station. The vehicle navigation unit 100 may provide the users with immediate information by displaying the alternative available charging station on the screen on a real-time basis. This information provision may serve as a basis for flexibly coping with an unexpected situation which may arise while the users drive the vehicle to the destination.

In addition, the connected service server unit 300 may generate a driving route of the users and a route to the charging station, and may provide the vehicle navigation unit 100 with the driving route of the users and the route to the charging station. Moreover, the connected service server unit 300 may transmit the driving route of the users and the route to the charging station to the charging station information unit 200 such that each unit may share information on the status of the charging station and the route to the charging station. Through this shared information, the charging station information unit 200 may more precisely monitor the status of the charging station in accordance with the derived route, and may continuously maintain a latest route by updating a failure status or a change in the waiting time of the charging station to the server on a real-time basis. This interaction may contribute to providing the users with an optimal charging experience by immediately reflecting the change in the status of the charging station in the route to the charging station.

The connected service server unit 300 may further improve a function of selecting the charging station and recommending the route through data analysis and prediction functions. The server may be equipped with a function of learning patterns, based on a failure frequency, a change in the waiting time, hourly occupancy, and the like of the charging station, and predicting potential problems under specific conditions.

For example, in a case of the charging station in which the waiting time tends to increase during a specific time zone or the charging station that frequently malfunctions (e.g., is frequently broken), the server may analyze this case in advance, and may recommend the users to select an alternative route such that the users can avoid the corresponding charging station. This recommendation may provide the users with a more stable charging experience by predicting and preparing for the changes in the status of the charging station, and may contribute to minimized inconvenience caused by the failure of the charging station.

In addition, based on the recommended route and the recommended charging station, the connected service server unit 300 may predict a time required for charging while the users drive the vehicle to the charging station, and may adjust (e.g., may automatically adjust) a charging route in accordance with a distance to the destination and an expected driving distance.

In particular, in a case of a user who plans to travel a long-distance, the server may generate a routes including a charging station required during the driving in advance, thereby reducing inconvenience of unnecessarily searching for the charging station or changing the route during driving. For example, when a battery capacity of the vehicle of the user is insufficient to arrive at the destination, the server may add (e.g., may automatically add) information on an intermediately located charging station, and may allow the user to arrive at the destination without worrying about charging.

The connected service server unit 300 may provide information to the users on a real-time basis to reset the route in accordance with the change in the status of the charging station. In this manner, the connected service server unit 300 may assist the users of the electric vehicle electric vehicle to stably use the charging station and to arrive at the destination of the users. Since the charging station is recommended by reflecting real-time data such as the failure information of the charging station, the users may avoid unnecessary waiting or visiting to the charging station that is malfunctioning (e.g., is broken). Accordingly, this recommendation may greatly improve convenience and reliability of the electric vehicles.

The destination information 110 transmitted to the charging station information unit 200 and the connected service server unit 300 by the vehicle navigation unit 100 may include first destination information in which the charging station is a destination or a transit point and second destination information in which the charging station is not the destination or the transit point. In this case. The first destination information and the second destination information may be distinguished and transmitted to the charging station information unit 200.

The first destination information in which the charging station is the destination or the transit point and the second destination information in which the charging station is not the destination or the transit point may be distinguished to differently monitor a failure status of the charging station in accordance with each information. Therefore, charging station failure information may be accurately generated.

The vehicle information 120 transmitted to the charging station information unit 200 and the connected service server unit 300 by the vehicle navigation unit 100 may include at least one of a location of the vehicle, whether the charging inlet door is open or closed, and/or whether the battery residual capacity is increased or decreased. This vehicle information 120 may be utilized to determine whether the charging station is in a malfunctioning (e.g., broken) state.

Location information of the vehicle may be generated based on an image received through a camera of the vehicle.

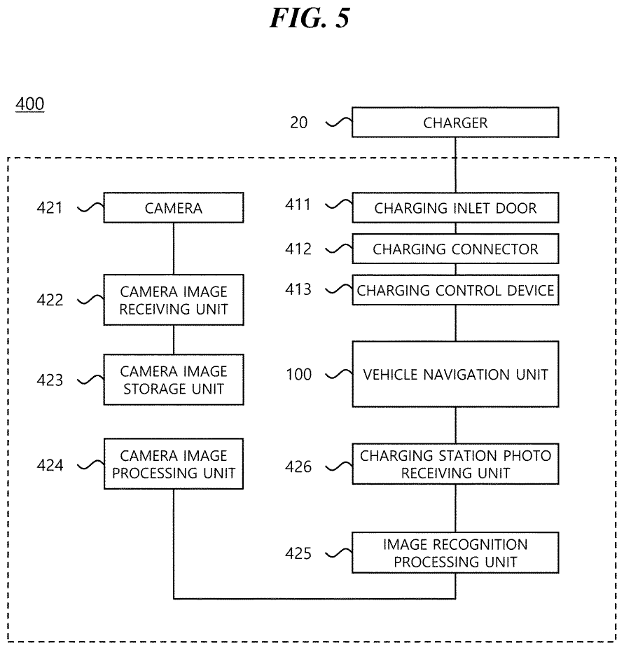

FIG. 5 is a diagram illustrating a configuration of a vehicle under charging, according to an embodiment.

Referring to FIG. 5, a vehicle under charging 400 may include a charging inlet door 411, a charging connector 412, and a charging control device 413 that are connected to the charger 20. The vehicle under charging 400 may transmit information to the vehicle navigation unit 100. In addition, the vehicle under charging 400 may include a camera 412, a camera image receiving unit 422, a camera image storage unit 423, a camera image processing unit 424, an image recognition processing unit 425, and a charging station photo receiving unit 426, and may transmit information to the vehicle navigation unit 100.

The camera 421 is a device that may capture and record an image of the status of the charging station on a real-time basis. This camera may be a device such as a black box, a rear camera, or an around view camera. This camera may collect images around the vehicle, may monitor the status of the charging station, may record the monitored status, and may provide a foundation for utilizing results in analyzing causes of any future problems.

The camera image receiving unit 422 may receive an image captured by the camera 421, and may transmit the received image data to a next stage for analysis or storage. This image transmitted to a server inside or outside the vehicle may be used as basic data for determining the status of the charging station.

The camera image storage unit 423 may store the image received from the camera image receiving unit 422. The stored image may be used to determine whether an abnormality occurs in the charging station. Furthermore, the stored image may be an important factor in securing data required for analyzing the failure information of the charging station. In addition, this data may be used to track a past state of the charging station and to discover a specific pattern.

The camera image processing unit 424 may analyze stored image data, and may convert the stored image data into meaningful information. The camera image processing unit 424 may recognize image data surrounding the charging station to identify an abnormal status of the charging station or whether the charging station is malfunctioning (e.g., is broken). Through this process, the users may take a real-time response to a change in the status of the charging station.

The image recognition processing unit 425 may compare the image the photo that are received from the camera 421 and the charging station photo receiving unit 426 to determine whether the charging station is currently normally operated. Through this process, the users and the operators may detect an abnormal status of the charging station earlier, thereby contributing to providing information to the users of the electric vehicles to avoid a charging stations that may have problems.

The charging station photo receiving unit 426 may receive the image data of the charging station from the charging station information unit 200, and may detect an external condition or a structural change in the charging station and to identify a failure or a condition requiring maintenance.

The charging inlet door 411 is a device that checks an open/closed status of a charging inlet. Since charging is available only when the charging inlet door is open, the charging inlet door 411 may provide conditions that the vehicle arriving at the charging station can start charging. Charging readiness may be determined by monitoring a status of this charging inlet door on a real-time basis.

The charging connector 412 is a connection portion between a charging cable and the vehicle. A charging connector recognition unit may be used to check whether the charging cable is properly connected to the vehicle. When the charging connector is not properly connected, it may be considered that charging is not started.

The charging control device 413 may control a charging process of the vehicle, and may have a function of determining whether the vehicle is charged. Through communication between the vehicle and the charging station, the charging control device 413 may check whether charging is started or stopped, and may notify the users of a charging status in accordance with a checking result.

The static information of the charging station may include at least one of an address of the charging station, the number of charging ports, a charging speed, a charging method, operating hours, and/or a charging rate.

In addition, the dynamic information of the charging station may include at least one of the number of vehicles waiting for charging, the number of vehicles under charging, a charger status, a communication status, and/or road congestion around the charging station.

The charging station information 210 may be generated based on the static information and the dynamic information of the charging station.

The failure information of the charging station may include first failure information including information on a defective charging port connector and second failure information including an error in a charger body.

The first failure information may be determined as a defective charging port connector and generated when the charging inlet door is open and closed, although the battery residual capacity is not increased.

The second failure information may be generated when the charging inlet door is open and closed and charging port connector connection is recognized, even though the battery residual capacity is not increased. The second failure information may be generated by determining an error in the charger body, for example, a payment error or a communication error.

Whether the charging station is malfunctioning (e.g., is broken), according to an embodiment, may be determined as follows. When the destination information received from the vehicle navigation unit 100 is the first destination information, and when it is determined that the vehicle arrives at the charging station, whether the charging station at which the vehicle arrives matches the charging station searched for through the camera of the vehicle is checked, whether the charging inlet door is open is checked, whether the battery residual capacity is increased or decreased is checked, and whether the charging inlet door is closed is checked.

In addition, whether the charging station is malfunctioning (e.g., is broken), according to an embodiment. may be determined as follows. When the destination information received from the vehicle navigation unit is the second destination information, whether the charging inlet door is open is checked, whether the charging station at which the vehicle arrives matches the charging station searched for through the camera of the vehicle in the charging stations around the vehicle which searched for through the GPS, whether the battery residual capacity is increased or decreased is checked, and whether the charging inlet door is closed is checked.

In an embodiment, when the same failure information of the same charging station is received from another vehicle within a certain period of time (e.g., twenty four (24) hours) after the failure information of the charging station is stored in the charging station database server for the first time, the charging station may be classified as a charging station having a confirmed failure.

Next, a method for determining whether the charging station is malfunctioning (e.g., is broken) according to an embodiment is described in more detail.

According to an embodiment of the present disclosure, a method for determining whether a charging station is malfunctioning (e.g., is broken) is provided. The method includes an information collection step of collecting destination information and vehicle information from a vehicle navigation unit and collecting a vehicle route from a connected service server unit, a charging station information deriving step of selecting static information and dynamic information of a charging station from a charging station information unit, based on the collected information, and deriving failure information of the charging station, and a charging station information provision step of deriving the charging station excluding a charging station having a confirmed failure, based on the derived charging station information, and providing the derived charging station to the vehicle navigation unit and the charging station information unit.

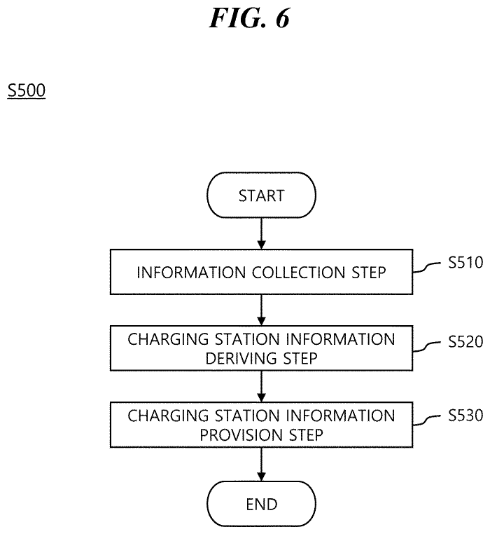

FIG. 6 is a flowchart illustrating the method for determining whether the charging station is malfunctioning (e.g., is broken) according to an embodiment.

Referring to FIG. 6, a method for determining whether the charging station is malfunctioning (e.g., is broken) S500 may include an information collection step S510, a charging station information deriving step (S520), and a charging station information provision step S530.

In the information collection step S510, the destination information 110 and the vehicle information 120 may be collected from the vehicle navigation unit 100, and the vehicle route 310 may be collected from the connected service server unit 300.

In the charging station information deriving step S520, based on the information collected in this way, the charging station information unit 200 may select the static information and the dynamic information of the charging station, and may derive the failure information of the charging station.

In the charging station information provision step S530, based on the derived charging station information, the vehicle route may be generated by deriving the charging station excluding the charging station having the confirmed failure.

The vehicle navigation unit 100 may receive the charging station information 210 from the charging station information unit 200, may display the charging station information 210 on the screen, may transmit the destination information 110 and the vehicle information 120 to the connected service server unit 300 and the charging station information unit 200, may receive the vehicle route from the connected service server unit 300, and may display the received vehicle route on the screen.

The vehicle navigation unit 100 may receive various static information and dynamic information on the charging station from the charging station information unit 200, and may display the static information and the dynamic information on the screen. The static information on the charging station may include at least one of an address of the charging station, number of charging ports, a charging speed, a charging method, operating hours, and/or a charging rate. Through this information, the users may select a basic charging station.

In addition, the vehicle navigation unit 100 may receive the dynamic information including at least one of the number of vehicles waiting for charging, the number of vehicles under charging, a charger status, a communication status, and road congestion around the charging station, and may provide the dynamic information to the users. In this manner, the vehicle navigation unit 100 may assist the users to select the charging station, based on real-time conditions. For example, when the charging station selected as a destination of the users is malfunctioning (e.g., is broken) or when the charging station unavailable due to a communication error, the vehicle navigation unit 100 may immediately display this information on the screen, and may enable the users to select an alternative charging station.

In addition, the vehicle navigation unit 100 may transmit destination information of the vehicle and current status information of the vehicle to the connected service server unit 300 and the charging station information unit 200. The reason may be to provide more personalized charging station information to the users. Since a driving distance of the vehicle, a battery's remaining capacity, and a time required for charging to the server, the connected service server unit 300 may calculate a charging route suitable for the status of the vehicle.

Functions of the vehicle navigation unit 100 may be operated not only as a simple route guidance function, but also as a comprehensive charging management system based on connectivity with the charging station. For example, real-time charging station status information allows the users to plan an access strategy to the charging station in advance by reflecting an expected situation upon arrival and a possible change in the charging station. Through these functions, the vehicle navigation unit 100 may enable the users to always select a reliable charging station while the users access the charging station, and may minimize unexpected inconveniences caused by the failure of the charging station when the users arrive at the charging station.

The charging station information unit 200 may select static information and dynamic information of the charging station, based on the destination information 110 and the vehicle information 120 received from the vehicle navigation unit 100 and the vehicle route 310 received from the connected service server unit 300, may derive the failure information of the charging station, may store the derived failure information in the charging station database server, and may provide the charging station information 210 to the vehicle navigation unit 100 and the connected service server unit 300.

In an embodiment, the charging station information unit 200 may collect status information of the charging station on a real-time basis, may analyze the status information, and may transmit the analyzed status information to the vehicle navigation unit 100 and the connected service server unit 300. The charging station information unit 200 may provide an efficient charging path to the users by accurately monitoring the status of the charging station and deriving the failure information and real-time charging availability. The charging station information unit 200 may select a status of each charging station, based on the static information and the dynamic information of the charging station, may extract the failure information, and may store the failure information in the charging station database server, thereby providing reliable real-time information for the users and operators.

The charging station information unit 200 may select required charging station information, based on the destination information 110 and the vehicle information 120 received from the vehicle navigation unit 100 and the vehicle route 310 received from the connected service server unit 300. This charging station information includes the static information such as a location of the charging station, a charging method, and the number of chargers, and the dynamic information such as a real-time standby status, whether the charging station is malfunctioning (e.g., is broken), and a communication status. Through this information, the charging station information unit may understand current requirements of the charging station needed by the vehicle, and may select and manages data essential on a real-time basis to provide the charging station information when the users access to the destination.

In addition, the charging station information unit 200 may continuously analyze the status data of each charging station to derive the failure information. In an embodiment, the charging station information unit 200 may continuously monitor a power supply status, an internal status of devices including the chargers, and a network communication status through various sensors, and may adopt an algorithm for determining whether the charging station is malfunctioning (e.g., is broken), based on this data.

In addition, the charging station information unit 200 may transmit the failure information on a real-time basis to the vehicle navigation unit 100 and the connected service server unit 300 to reflect availability of the charging station. When a status of the selected charging station is changed to a failure status while the users access the charging station along the route, the charging station information unit 200 may quickly update the information. In this manner, the charging station information unit 200 may guide the users to immediately reset the route, or may suggest the users to select an alternative charging station.

The connected service server unit 300 may receive the charging station information 210 from the charging station information unit 200, and based on the received charging station information 210, the connected service server unit 300 may derive a charging station excluding a charging station having a confirmed failure, may generate the vehicle route 310, and may provide the generated vehicle route 310 to the vehicle navigation unit 100 and the charging station information unit 200.

In an embodiment, the connected service server unit 300 is a system operated in close conjunction with the charging station information unit 200 and the vehicle navigation unit 100 to provide the users with information on the charging station and the driving route. In particular, the system may provide the users with a route including only the reliable charging station by reflecting the failure information of the charging station on a real-time basis. The connected service server unit 300 may receive a real-time status and related information of the charging station from the charging station information unit, may analyze the real-time status and the related information of the charging station, and may select the charging station excluding the charging station having the confirmed failure, thereby providing the users with an efficient route.

The connected service server unit 300 may accurately identify a status of the charging station, based on the charging station information 210 provided by the charging station information unit 200. The charging station information unit 200 may identify the static information and the dynamic information of each charging station. The static information and the dynamic information may include not only basic information such as a location of the charging station, a charging speed, and the number of chargers, but also a real-time status of the charging station, whether the charging station is malfunctioning (e.g., is broken), and a communication status. The connected service server unit 300 may determine the availability of the charging station on a real-time basis through the identified information, and may secure a criterion for excluding the charging station having the confirmed failure when recommending the charging station suitable for the users. For example, when it is confirmed that the charging station is currently malfunctioning (e.g., is currently broken), the connected service server unit 300 may immediately exclude the charging station having the confirmed failure, and may select only the available charging station.

The connected service server unit 300 may perform a process of deriving the charging station to the users, based on the provided charging station information 210. In this case, the charging station may be determined by comprehensively considering a battery residual capacity, a current location, a distance to a driving destination, an expected charging time, and the like of the vehicle of the users. For example, when the users travel a long distance or pass through an area having an insufficient charging infrastructure, the server may design a route to provide a stable route to the users by identifying the available charging stations in advance. In this process, detailed information such as a charging waiting time and a charging speed of each charging station may be considered together, and the server may calculate and provide a route including the charging station information to the users, based on this detailed information.

The destination information 110 transmitted to the charging station information unit 200 and the connected service server unit 300 by the vehicle navigation unit 100 may include first destination information in which the charging station is a destination or a transit point and second destination information in which the charging station is not the destination or the transit point. In this case, the first destination information and the second destination information may be distinguished and transmitted to the charging station information unit 200.

The first destination information in which the charging station is the destination or the transit point and the second destination information in which the charging station is not the destination or the transit point may be distinguished to differently monitor a failure status of the charging station in accordance with each information. Therefore, charging station failure information can be accurately generated.

The vehicle information 120 transmitted to the charging station information unit 200 and the connected service server unit 300 by the vehicle navigation unit 100 may include at least one of a location of the vehicle, whether the charging inlet door is open or closed, and/or whether the battery residual capacity is increased or decreased. This vehicle information 120 may be utilized to determine whether the charging station is in a malfunctioning (e.g., broken) state.

Location information of the vehicle may be generated based on an image received through a camera of the vehicle.

The camera (e.g., the camera 421) is a device that may capture and record an image of the status of the charging station on a real-time basis. This camera may be a device such as a black box, a rear camera, or an around view camera. This camera may collect images around the vehicle, may monitor the status of the charging station, may record the monitored status, and may provide a foundation for utilizing results in analyzing causes of any future problems.

A camera image receiving unit (e.g., the camera image receiving unit 422) may receive an image captured by the camera, and may transmit the received image data to a next stage for analysis or storage. This image transmitted to a server inside or outside the vehicle may be used as basic data for determining the status of the charging station.

A camera image storage unit (e.g., the camera image storage unit 423) may store the image received from the camera image receiving unit. The stored image may be used to determine whether an abnormality occurs in the charging station. Furthermore, the stored image plays an important factor in securing data required for analyzing the failure information of the charging station. In addition, this data may be used to track a past state of the charging station and to discover a specific pattern.

A camera image processing unit 424 (e.g., the camera image processing unit 424) may analyze stored image data, and may convert the stored image data into meaningful information. The camera image processing unit may recognize image data surrounding the charging station to identify an abnormal status of the charging station or whether the charging station is malfunctioning (e.g., is broken). Through this process, the users may take a real-time response to a change in the status of the charging station.

An image recognition processing unit (e.g., the image recognition processing unit 425) may compare the image the photo which are received from the camera and the charging station photo receiving unit to determine whether the charging station is currently normally operated. Through this process, the users and the operators may detect an abnormal status of the charging station earlier, thereby contributing to providing information to the users of the electric vehicles to avoid a charging stations that may have problems.

A charging station photo receiving unit (e.g., the charging station photo receiving unit 426) may receive the image data of the charging station from the charging station information unit 200, and may detect an external condition or a structural change in the charging station and to identify a failure or a condition requiring maintenance.

A charging inlet door (e.g., the charging inlet door 411) is a device that checks an open/closed status of a charging inlet. Since charging is available only when the charging inlet door is open, the charging inlet door may provide conditions that the vehicle arriving at the charging station can start charging. Charging readiness may be determined by monitoring a status of this charging inlet door on a real-time basis.

A charging connector (e.g., the charging connector 412) is a connection portion between a charging cable and the vehicle. A charging connector recognition unit may be used to check whether the charging cable is properly connected to the vehicle. When the charging connector is not properly connected, is may be considered that charging is not started.

A charging control device (e.g., the charging control device 413) may control a charging process of the vehicle, and may have a function of determining whether the vehicle is charged. Through communication between the vehicle and the charging station, the charging control device may check whether charging is started or stopped, and notifies the users of a charging status in accordance with a checking result.

The static information of the charging station may include at least one of an address of the charging station, the number of charging ports, a charging speed, a charging method, operating hours, and/or a charging rate.

In addition, the dynamic information of the charging station may include at least one of the number of vehicles waiting for charging, the number of vehicles under charging, a charger status, a communication status, and/or road congestion around the charging station.

The charging station information 210 may be generated based on the static information and the dynamic information of the charging station.

The failure information of the charging station may include first failure information including information on a defective charging port connector and second failure information including an error in a charger body.

The first failure information may be determined as a defective charging port connector and generated when the charging inlet door is open and closed, although the battery residual capacity is not increased.

The second failure information may be generated when the charging inlet door is open and closed and charging port connector connection is recognized, even though the battery residual capacity is not increased. The second failure information may be generated by determining an error in the charger body, for example, a payment error or a communication error.

Whether the charging station is malfunctioning (e.g., is broken), according to an embodiment, may be determined as follows. When the destination information received from the vehicle navigation unit 100 is the first destination information, and when it is determined that the vehicle arrives at the charging station, whether the charging station at which the vehicle arrives matches the charging station searched for through the camera of the vehicle is checked, whether the charging inlet door is open is checked, whether the battery residual capacity is increased or decreased is checked, and whether the charging inlet door is closed is checked.

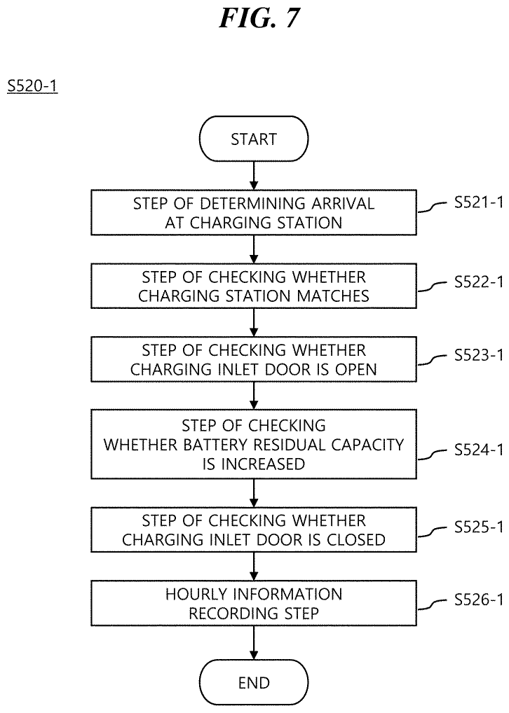

FIG. 7 is a flowchart illustrating a first method for determining whether a charging station is malfunctioning (e.g., is broken), according to an embodiment.

Referring to FIG. 7, a first method for determining whether the charging station is malfunctioning (e.g., is broken) S520-1 may include a step of determining arrival at the charging station S521-1, a step of checking whether the charging station matches S522-1, a step of checking whether the charging inlet door is open S523-1, a step of checking whether the battery residual capacity is increased S524-1, a step of checking whether the charging inlet door is closed S525-1, and an hourly information recording step S526-1.

The first destination information is information on whether the charging station is a destination or a transit point. Based on this information, it may be first determined whether the vehicle arrives at the charging station. Thereafter, it can be checked through a camera (e.g., the camera 421) of the vehicle whether the charging station at which the vehicle arrives matches the charging station set as the destination or the transit point in the navigation system. Thereafter, it may be checked whether the charging inlet door is open, it may be whether the battery residual capacity is increased, and it may be checked whether the charging inlet door is closed. For example, when the battery residual capacity is not increased and the charging inlet door is closed although the charging inlet door is open, it may be determined as a defective connector. In addition, when the inlet door is closed after disconnection although it is recognized that the charging connector is connected, it may be determined that the charger or the payment system has an error.

This information may be stored in the server on an hourly basis.

In an embodiment, even when it is not recognized whether the inlet door is closed, it may be recognized that the inlet door is closed when the vehicle departs.

In addition, whether the charging station is malfunctioning (e.g., is broken), according to an embodiment, may be determined as follows. When the destination information received from the vehicle navigation unit is the second destination information, whether the charging inlet door is open is checked, whether the charging station at which the vehicle arrives matches the charging station searched for through the camera of the vehicle in the charging stations around the vehicle which searched for through the GPS, whether the battery residual capacity is increased or decreased is checked, and whether the charging inlet door is closed is checked.

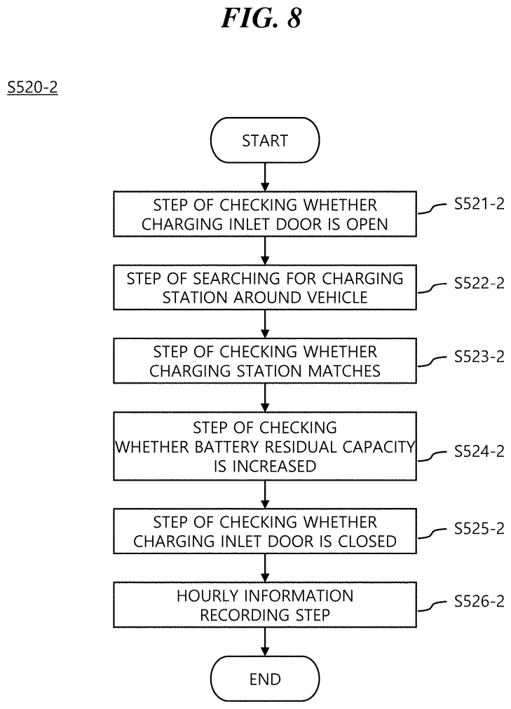

FIG. 8 is a flowchart illustrating a second method for determining whether a charging station is malfunctioning (e.g., is broken), according to an embodiment.

Referring to FIG. 8, a second method for determining whether the charging station is malfunctioning (e.g., is broken) S520-2 may include a step of checking whether the charging inlet door is open S521-2, a step of searching for the charging station around the vehicle S522-2, a step of checking whether the charging station matches S523-2, a step of checking whether the battery residual capacity is increased S524-2, a step of checking whether the charging inlet door is closed S525-2, and an hourly information recording step S526-2.

The second destination information is information that the charging station is not the destination or the transit point, and based on the second destination information, it may be first determined whether the charging inlet door is open. When the charging inlet door is open, the charging stations around the vehicle may be searched for through the GPS to select a candidate charging station. Whether the charging station matches may be confirmed through the image confirmed through a camera (e.g., the camera 421) of the vehicle.

Thereafter, it may be checked whether the battery residual capacity is increased, and it may be checked whether the charging inlet door is closed. For example, when the battery residual capacity is not increase and the charging inlet door is closed, although the charging inlet door is open, it may be determined as a defective connector. In addition, when the inlet door is closed after disconnection although it is recognized that the charging connector is connected, it may be determined that the charger or the payment system has an error.

This information may be stored in the server on an hourly basis.

In an embodiment, even when it is not recognized whether the inlet door is closed, it may be recognized that the inlet door is closed when the vehicle departs.

In an embodiment, when the same failure information of the same charging station is received from another vehicle within a certain time period (e.g., twenty four (24) hours) after the failure information of the charging station is stored in the charging station database server for the first time, the charging station may be classified as a charging station having a confirmed failure.

According to an embodiment, a non-transitory computer-readable medium having instructions stored thereon us provided. The instructions, when executed by a computer (e.g., one or more processors), cause the computer (e.g., the one or more processors) to execute the method for determining whether the charging station is malfunctioning (e.g., is broken).

The terms “including,” “configuring,” or “having” used herein, unless otherwise specifically described, the terms mean that the corresponding components may be internally interposed. Therefore, it should be construed that other components may be further included rather than excluding the other components. Unless otherwise defined, all terms including technical or scientific terms have meanings the same as meanings commonly understood by those having ordinary skill in the art to which the present disclosure pertains. Commonly used terms, such as terms defined in dictionaries, should be interpreted to be consistent with the meanings in the context of the related art, and should not be interpreted in an idealized or overly formal sense, unless explicitly defined in the present disclosure.

The above description is merely an example of the technical idea of the present disclosure, and those having ordinary skill in the art to which the present disclosure pertains may adopt various corrections and modifications without departing from the essential characteristics of the present disclosure. Therefore, the embodiments described in the present disclosure are not intended to limit the technical idea of the present disclosure, and are intended to describe the technical idea of the present disclosure. The scope of the technical idea of the present disclosure is not limited by the described embodiments. The scope of the present disclosure should be interpreted by the appended claims, and all technical ideas within the scope equivalent thereto should be interpreted as being included in the scope of the present disclosure.

What is claimed is:

1. A charging station failure information provision system comprising:
a vehicle navigation unit configured to receive charging station information from a charging station information unit, display the charging station information on a screen, transmit destination information and vehicle information of a vehicle to a connected service server unit and a charging station information unit, receive a vehicle route from the connected service server unit, and display vehicle route on the screen,
wherein:
the charging station information unit is configured to select static information and dynamic information of a charging station, based on the destination information and the vehicle information received from the vehicle navigation unit and the vehicle route received from the connected service server unit, and
the connected service server unit is configured to receive the charging station information from the charging station information unit, derive charging stations excluding a charging station having a confirmed failure, based on the received charging station information, and provide the derived charging stations to the vehicle navigation unit and the charging station information unit.

2. The charging station failure information provision system of claim 1, wherein the destination information includes first destination information in which the charging station is a destination or a transit point and second destination information in which the charging station is not the destination or the transit point, and wherein the first destination information and the second destination information are distinguished and transmitted to the charging station information unit.

3. The charging station failure information provision system of claim 1, wherein the charging station information unit is configured to:
derive failure information of the charging station;
store the derived failure information of the charging station in a charging station database server; and
provide the stored failure information of the charging station to the vehicle navigation unit and the connected service server unit.

4. The charging station failure information provision system of claim 3, wherein location information of a vehicle is generated based on an image received through a camera of the vehicle.

5. The charging station failure information provision system of claim 1, wherein the static information of the charging station includes at least one of an address of the charging station, a number of charging ports, a charging speed, a charging method, operating hours, or a charging rate.

6. The charging station failure information provision system of claim 1, wherein the dynamic information of the charging station includes at least one of a number of vehicles waiting for charging, a number of vehicles under charging, a charger status, a communication status, or road congestion around the charging station.

7. The charging station failure information provision system of claim 2, wherein the failure information of the charging station includes first failure information including information on a defective charging port connector and second failure information including an error in a charger body.

8. The charging station failure information provision system of claim 7, wherein:
the destination information received from the vehicle navigation unit is the first destination information; and
based on determining that a vehicle arrives at the charging station, whether the charging station is malfunctioning is determined by checking whether the charging station at which the vehicle arrives matches a charging station searched for through a camera of the vehicle, checking whether a charging inlet door is open, checking whether a battery residual capacity is increased or decreased, and checking whether the charging inlet door is closed.

9. The charging station failure information provision system of claim 7, wherein:
the destination information received from the vehicle navigation unit is the second destination information; and
whether the charging station is malfunctioning is determined by checking whether a charging inlet door is open, identifying a charging station that matches a charging station searched for through a camera of the vehicle in charging stations around the vehicle which are searched for through global positioning system (GPS), checking a battery residual capacity is increased or decreased, and checking whether the charging inlet door is closed.

10. The charging station failure information provision system of claim 7, wherein the first failure information is generated based on determining that a charging inlet door is open and closed, even when a battery residual capacity is not increased.

11. The charging station failure information provision system of claim 7, wherein the second failure information is generated based on determining that a charging inlet door is open and closed and charging port connector connection is recognized, even when a battery residual capacity is not increased.

12. The charging station failure information provision system of claim 1, wherein when a same failure information of a same charging station is received from another vehicle within a certain period of time after the failure information of the charging station is stored in a charging station database server for the first time, the charging station is classified as a charging station having a confirmed failure.

13. A method for determining whether a charging station is malfunctioning, the method comprising:
collecting destination information and vehicle information from a vehicle navigation unit in a vehicle;
collecting a vehicle route from a connected service server unit;
selecting static information and dynamic information of a charging station from a charging station information unit, based on the collected information, and deriving failure information of the charging station;
deriving a charging station excluding a charging station having a confirmed failure, based on derived charging station information; and
providing the derived charging stations to the vehicle navigation unit and the charging station information unit.

14. The method of claim 13, wherein the destination information includes first destination information in which the charging station is a destination or a transit point and second destination information in which the charging station is not the destination or the transit point, and wherein the first destination information and the second destination information are distinguished and transmitted to the charging station information unit.

15. The method of claim 13, wherein the static information of the charging station includes at least one of an address of the charging station, a number of charging ports, a charging speed, a charging method, operating hours, or a charging rate.

16. The method of claim 13, wherein the dynamic information of the charging station includes at least one of a number of vehicles waiting for charging, a number of vehicles under charging, a charger status, a communication status, or road congestion around the charging station.

17. The method of claim 14, wherein the failure information of the charging station includes first failure information including information on a defective charging port connector and second failure information including an error in a charger body.

18. The method of claim 17, wherein:
the destination information received from the vehicle navigation unit is the first destination information; and
the method further includes, based on determining that a vehicle arrives at the charging station, determining whether the charging station is malfunctioning by checking whether the charging station at which the vehicle arrives matches a charging station searched for through a camera of the vehicle, checking whether a charging inlet door is open, checking whether a battery residual capacity is increased or decreased, and checking whether the charging inlet door is closed.

19. The method of claim 17, wherein:
the destination information received from the vehicle navigation unit is the second destination information; and
the method further includes determining whether the charging station is malfunctioning by checking whether a charging inlet door is open, identifying a charging station that matches a charging station searched for through a camera of the vehicle in charging stations around the vehicle which are searched for through global positioning system (GPS), checking a battery residual capacity is increased or decreased, and checking whether the charging inlet door is closed.

20. A non-transitory computer-readable medium having stored thereon instructions that, when executed by one or more processors, cause the one or more processors to:
collect destination information and vehicle information from a vehicle navigation unit;
collecting a vehicle route from a connected service server unit;
select static information and dynamic information of a charging station from a charging station information unit, based on the collected information, and deriving failure information of the charging station;
derive a charging station excluding a charging station having a confirmed failure, based on derived charging station information; and
provide the derived charging stations to the vehicle navigation unit and the charging station information unit.
